(19) United States
(12) Patent Application Publication
(10) Pub. No.: US 2012/0102007 A1
(43) Pub. Date: Apr. 26, 2012

(54) MANAGING ETL JOBS

(75) Inventors: Srividya Ramasubramanian, Woodridge, IL (US); Peter Wokwicz, South Barrington, IL (US)

(73) Assignee: Alpine Consulting, Inc.

(21) Appl. No.: 12/910,689

(22) Filed: Oct. 22, 2010

(51) Int. Cl. G06F 7/00; G06F 17/30

(52) U.S. Cl. 707/705; 707/E17.001

(57) ABSTRACT

The management of extract, transform, and load jobs techniques include a method, system, and/or a computer readable storage medium. In some embodiments of these techniques, the method includes receiving a log containing data for one or more events associated with an ETL job. The method further includes identifying one or more job runs for the ETL job using start event and end event data stored in the log. The method further includes aggregating the one or more events for each identified job run based on one or more event fields in the log. The method further includes determining an identifier for each aggregated group of events. The method further includes storing the one or more events with the corresponding identifiers in a database.

### FIELD

The present invention relates generally to computer-based methods and apparatuses, including computer program products, for managing extract, transform, and load (ETL) activities.

### BACKGROUND

Modern business systems often involve the integration of numerous data sources, applications, and processes with ETL tools being used to facilitate integration. An ETL tool involves extracting data from data sources, transforming the extracted data, and loading it into an end target system (e.g., data warehouse, database, etc.). An ETL process may extract data from multiple sources, and join the data into a single target system. During the transformation step, the data may be manipulated to fit the structure of the target database. For example, only certain columns can be selected to load into the end target database. An ETL tool may manage numerous ETL jobs handling large volumes of data.

ETL developers, data architects, and administrators lack the diagnostics and visibility necessary to keep their systems operating smoothly and efficiently.

### SUMMARY

One approach to managing extract, transform, and load (ETL) jobs is a method. The method includes receiving a log containing data for one or more events associated with an ETL job. The method further includes identifying one or more job runs for the ETL job using start event and end event data stored in the log. The method further includes aggregating the one or more events for each identified job run based on one or more event fields in the log. The method further includes determining an identifier for each aggregated group of events. The method further includes storing the one or more events with the corresponding identifiers in a database.

Another approach to managing extract, transform, and load (ETL) jobs is a method. The method includes receiving data for a group of ETL jobs, the group data including data for one or more ETL jobs. The method further includes storing the received group data in a database. The database stores event data associated with the one or more ETL jobs. The method further includes providing a user interface to display consolidated data associated with the one or more ETL jobs using the group data.

### BRIEF DESCRIPTION OF THE DRAWINGS

Various embodiments taught herein are illustrated by way of example, and not by way of limitation, in the figures of the accompanying drawings, in which:

FIG. 1 is a block diagram illustrating an exemplary system, according to one exemplary embodiment;

FIG. 2 is a block diagram illustrating an exemplary ETL data management system storing data from an exemplary ETL tool, according to one exemplary embodiment;

FIG. 3 is a block diagram illustrating an exemplary ETL data management server, according to one exemplary embodiment;

FIG. 4 is a block diagram illustrating an exemplary client device, according to one exemplary embodiment;

FIG. 5 is a flowchart illustrating managing job activity data, according to one exemplary embodiment;

FIGS. 6A-6N are illustrating exemplary user interfaces, according to exemplary embodiments;

FIG. 7 is a block diagram illustrating an exemplary logical data model, according to exemplary embodiments;

FIG. 8 is a block diagram illustrating exemplary flow of data; and

FIG. 9 is a block diagram illustrating an exemplary dashboard.

It will be recognized that some or all of the figures are schematic representations for purposes of illustration and do not necessarily depict the actual relative sizes or locations of the elements shown. The figures are provided for the purpose of illustrating one or more embodiments of the invention with the explicit understanding that they will not be used to limit the scope or the meaning of the claims.

### DETAILED DESCRIPTION OF EXEMPLARY EMBODIMENTS

Before turning to the figures which illustrate the exemplary embodiments in detail, it should be understood that the disclosure is not limited to the details or methodology set forth in the description or illustrated in the figures. It should also be understood that the terminology is for the purpose of description only and should not be regarded as limiting. One or more embodiments described herein may comprise an ETL performance dashboard that provides administrators with information on the performance of key ETL processes.

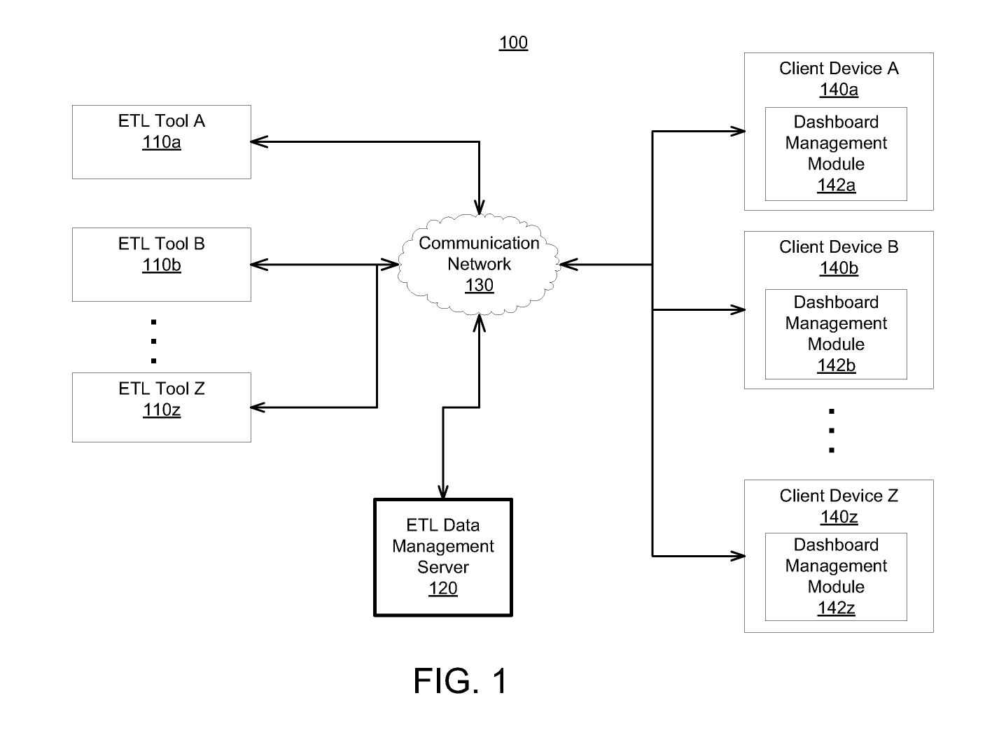

FIG. 1 illustrates an exemplary system 100 for managing ETL processes performed by ETL tools A 110a, B 110b, through Z 110z. The system includes an ETL data management server 120, a communication network 130 (e.g., internet protocol (IP) network, a local area network (LAN), internet, etc.) and client devices A 140a, B 140b through Z 140z.

Each client device A 140a, B 140b through Z 140z includes a dashboard management module 142a, 142b though 142z, respectively. The ETL tools A 110a, B 110b, through Z 110z, the client devices 140a-140z, and/or the ETL data management server 120 communicate via the communication network 130.

The ETL data management server 120 can manage data extracted by the ETL tools A 110a, B 110b, through Z 110z. The ETL data management server 120 can extract and analyze logs and other data associated with the ETL tools A 110a, B 110b, through Z 110z. The ETL data management server 120 can aggregate data from the ETL logs. The ETL data management server 120 can communicate with the dashboard management modules 142a-142z on each client device 140a-140z to provide users with insight into performance of the ETL processes performed by the ETL tools 110a through 110z.

Although FIG. 1 illustrates a single communication network 130, the system can include a plurality of communication networks and/or the plurality of communication networks can be configured in a plurality of ways (e.g., a plurality of interconnected local area networks (LAN), a plurality of interconnected wide area networks (WAN), a plurality of interconnected LANs and/or WANs, etc.).

Although FIG. 1 illustrates the ETL tools A 110a, B 110b through Z 110z, and the client devices A 140a, B 140b through Z 140z, the system 100 can include any number of ETL tools, and/or client devices.

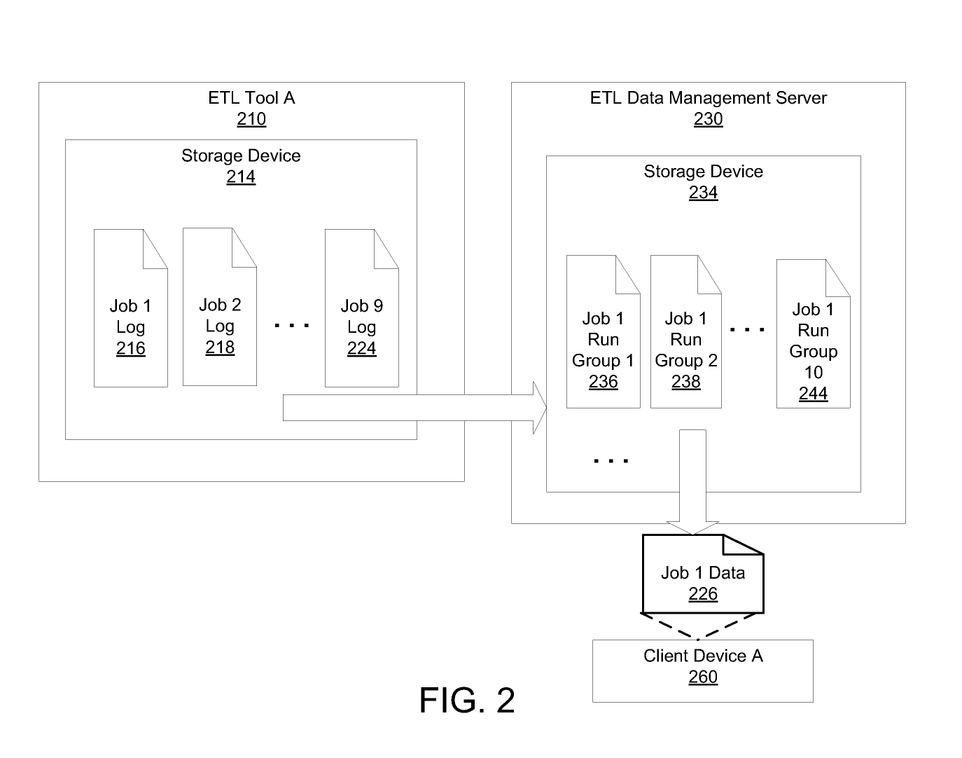

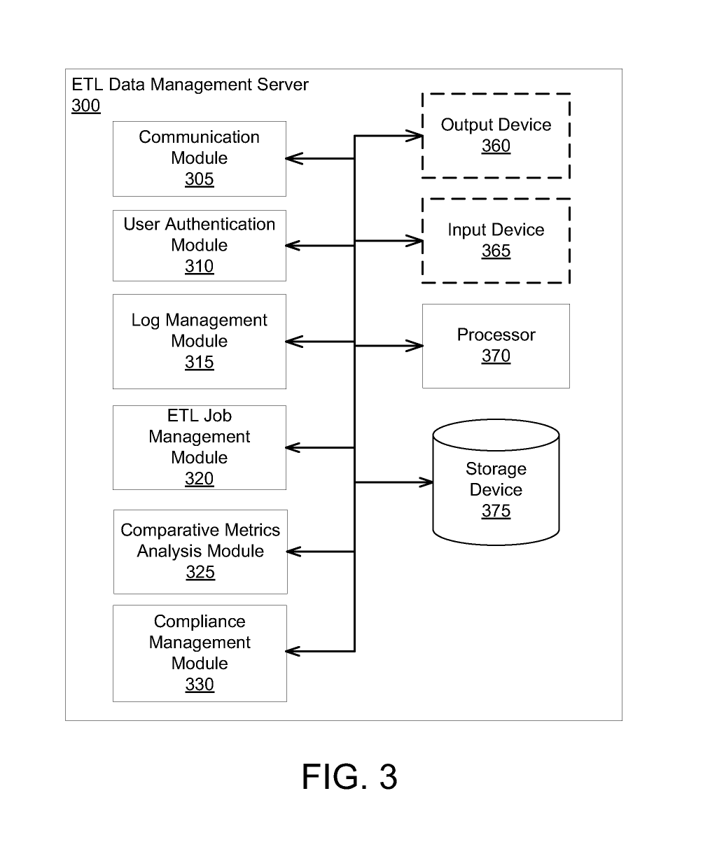

FIG. 2 illustrates an exemplary transfer of log data from an ETL tool A 210 to an ETL data management server 230. The ETL tool A 210 is shown to include a storage device 214. The storage device 214 is illustrated to store logs 216, 218 through 224 for jobs 1, 2, through 9. In some embodiments, each of these logs 216, 218 through 224 may store data associated with a single ETL job. In other embodiments, logs can store data associated with one or more ETL jobs. In other embodiments, the ETL tool A 210 may store a single log for all ETL jobs managed by the ETL tool A 210. A job may represent ETL job activity. Each job may be in various states such as success, aborted, running, etc.

The ETL data management server 230 may extract logs 216, 218 through 224 from the ETL tool A 210. In some embodiments, the storage device 234 may store the extracted logs 216, 218 through 224. The entire contents or alternatively portions of the extracted logs may be stored in the storage device 234. In some embodiments, the ETL data management server 230 may transform log information extracted from an ETL tool such as the ETL tool A 210 and segment it into well-identifiable job constructs. For example, events may be grouped or consolidated into one or more job runs. The job runs may be grouped into one or more run groups. In some embodiments, the grouping of events into job runs advantageously organizes the events created by ETL processes. In some embodiments, an event associated with a job may be the lowest granular information associated with a job that has been executed. Job events may show runtime occurrences of jobs as well as associated activity timestamps with corresponding details. A run group may represent a congregation of events that constitute a job. Information associated with a job run may include data regarding one or more events, which define start time, end time, and state of a job.

Aggregate event data may be stored in the storage device 234 of the ETL data management server 230. For example, as illustrated, data for run groups (e.g., 236, 238 through 244) may be stored in the storage device 234. In some embodiments, a client device A 260 may request the aggregated data (e.g., 236, 238, through 244) for further processing and/or display to the user via a user interface. Using one or more user interfaces, the client device A 260 may display to users data associated with ETL processes performed by one or more ETL tools (e.g, ETL tool A 210).

FIG. 3 illustrates an ETL data management server 300. The ETL data management server 300 includes a communication module 305, a user authentication module 310, a log management module 315, an ETL job management module 320, a comparative metrics analysis module 325, a compliance management module 330, an output device 360, an input device 365, a processor 370, and a storage device 375. The modules and/or devices can be hardware and/or portions of circuitry programmed with software or code. The modules and/or devices illustrated in the ETL data management server 300 can, for example, utilize the processor 370 to execute computer executable instructions and/or include a processor to execute computer executable instructions (e.g., a microprocessor, an encryption processing unit, a field programmable gate array processing unit, analog and/or digital components, etc.).

It should be understood that the ETL data management server 300 can include, for example, other modules, devices, and/or processors known in the art and/or varieties of the illustrated modules, devices, and/or processors. It should be understood that the modules and/or devices illustrated in the ETL data management server 300 can be located within the ETL data management server 300 and/or connected to the ETL data management server 300 (e.g., directly, indirectly, etc.), but outside of the physical components of the management server (e.g., server computer, shared, scaleable computers such as a cloud computing environment, personal computer, mobile device, etc.).

The communication module 305 communicates data to/from the ETL data management server 300. The user authentication module 310 authenticates users to the ETL data management server 300. The log management module 315 extracts log data from one or more ETL tools. The log management module 315 manages extracted log data. The log data may include event data associated with one or more jobs. The event data may include event timestamp, job identification information, event type (e.g., start, information, batch, finish, etc.), and/or message description, etc.

The ETL job management module 320 may aggregate the data associated with jobs (e.g., event data). For example, the log management module 315 may aggregate event data into groups such as job runs. A job run may be a set of events which define start time, end time, and state of the job. The ETL job management module 320 may aggregate event data into run groups. In some embodiments, the log management module 315 may identify start event activity and end event activity of a job. In some embodiments, once the start and end event activity are identified, the ETL job management module 320 may generate a run group identification and/or update records with the generated run group identification. In these embodiments, all the corresponding events which occur between the start and end event of a job may have the same run group identification. The ETL job management module 320 may store aggregated data in the data storage device 375. The user preference module 335 manages preferences of users and/or collects information associated with user selections and/or preferences.

The ETL job management module 320 may detect an ETL activity that should have been active but that did not occur. For example, custom rules may be defined in order to identify the required occurrence of a job (e.g., using rules engine 860). These rules (including run time rules) may be pre-defined by a user via one or more custom interfaces. In some embodiments, one or more rules may be defined for a job. The ETL job management module 320 may determine when a job was required to occur based on actual occurrence of the job from the log activity as compared to the pre-defined rules. The comparison would provide the deviations of the actual job occurrences to the expected job occurrences. For example, rule 1 may state that job 123 is run on Thursdays. In this example, at least one job run must occur on Thursday for the job 123. If there are no events associated to the start of the job 123 for Thursday, then the ETL job management module 320 may generate a message indicating that the job 123 did not run. For example, an email alert stating that the job 123 did not run may be sent to an administrator.

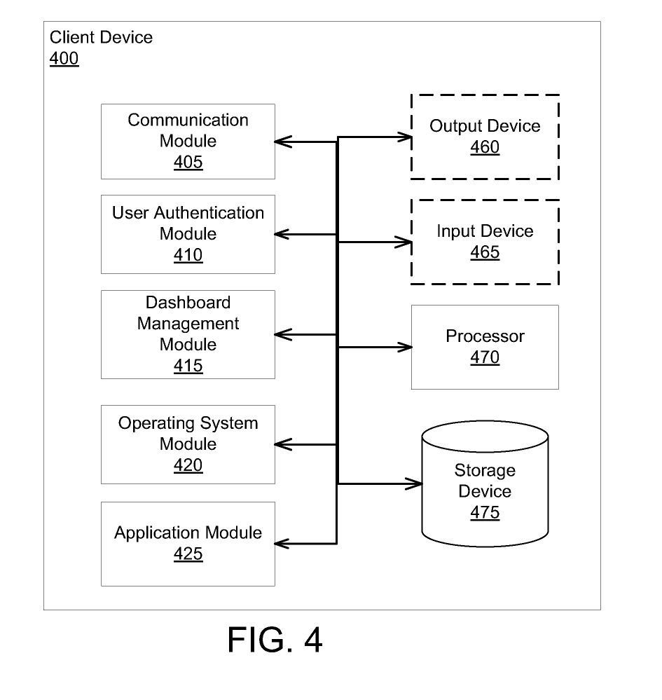

The comparative metrics analysis module 325 may utilize pre-defined comparative metrics for determining variance and standard deviations of the present job activities against the past occurrences of job activities. The calculated deviations may be stored in the storage device 375 or in the storage device 475 (e.g., client device, FIG. 4). In some embodiments, the differential metrics may be derived from self patterning of deviations from norm of events. In these embodiments, baseline metrics may be derived from the average or mean run time of a job. For example, the mean of the job runtime for job N may equal the total runtime of job N for the past 20 job runs divided by 20. After deriving the mean or average against the past job runs, the comparative metrics analysis module 325 may compute the standard deviation from the current job run. Using the standard deviation formula below, the standard deviation of the jobs runs may equal the summation of the square of each (job runtime minus mean of job run time), divided by the number of job runs minus 1.

$$s = \sqrt{\frac{{\sum }_{i = i}^{N} {( {x}_{i} - x )}^{2}}{N - 1}}$$

Accordingly, the comparative metrics analysis module 325 may detect any difference in the job performance.

In some embodiments, using the historical data of job occurrences, the comparative metrics analysis module 325 may define comparative metrics based on past performance of job runs. In other embodiments, one or more user interfaces (e.g., provided by a dashboard management module 415) may enable users to define the comparative metrics and/or view deviations of present job activities. The mathematical comparisons may be based on timeframes customizable by the end user. In some embodiments, the deviations from past job activities may be aggregated into job groups.

The compliance management module 330 may be used to monitor compliance of ETL activity with one or more agreements. For example, one or more pre-defined service level agreements may be used for monitoring performance of ETL jobs. In some embodiments, users may configure runtime as well as pre-defined rules to drive the ETL performance analysis. Users may be able to define custom rules for monitoring ETL performance. In some embodiments, the user can select a date and time when the rule is scheduled to be triggered. The user can also select one or more parameters associated with the rule (e.g., job success is the outcome of the rule). For example, the user may define a rule requiring that a job needs to complete in six hours or less on a particular day in order to be considered successful.

In some embodiments, the rules defined by users may be stored in the storage device 375 (e.g., rules table in a database). The compliance management module 330 may process the events against the rules defined by the users in order to determine jobs outcomes. For example, a rule may state that a job needs to run today. In this example, the compliance management module 330 may determine whether the events associated with the job indicate that the job was run today. In some embodiments, when the compliance management module 330 detects non-compliance with the pre-defined rules for ETL jobs, it may transmit an alert (e.g., email alert) to one or more users.

The output device 360 outputs information and/or data associated with the ETL data management server 300 (e.g., information to a printer (not shown), information to a speaker, etc.). The input device 365 receives information associated with the ETL data management server 300 (e.g., instructions from a user, instructions from a computing device, etc.) from a user (not shown) and/or a computing system (not shown). The input device 365 can include, for example, a keyboard, a scanner, etc.

The processor 370 executes the operating system and/or any other computer executable instructions for the management server (e.g., executes applications, etc.). The ETL data management server 300 can include random access memory (not shown). The random access memory can temporarily store the operating system, the instructions, and/or any other data associated with the management server. The random access memory can include one or more levels of memory storage (e.g., processor register, storage disk cache, main memory, etc.).

The storage device 375 stores the historical data of job runs, data associated with jobs (e.g., project name, events, etc.), user preferences, access information, an operating system and/or any other data associated with the ETL data management server 300. The storage device can include a plurality of storage devices. The storage device 375 can include, for example, long-term storage (e.g., a hard drive, a tape storage device, flash memory, etc.), short-term storage (e.g., a random access memory, a graphics memory, etc.), and/or any other type of computer readable storage.

Although FIG. 3 illustrates the exemplary ETL data management server 300, any of the management servers described herein (e.g., data center management server) can include the components and functionality described with respect to the ETL data management server 300.

FIG. 4 illustrates an exemplary client device 400. The client device 400 includes a communication module 405, a user authentication module 410, a dashboard management module 415, an operating system module 420, an application module 425, an output device 460, an input device 465, a processor 470, and a storage device 475. The modules and/or devices can be hardware and/or portions of circuitry programmed with software or code. The modules and/or devices illustrated in the client device can, for example, utilize the processor to execute computer executable instructions and/or include a processor to execute computer executable instructions (e.g., a microprocessor, an encryption processing unit, a field programmable gate array processing unit, analog and/or digital components, etc.).

It should be understood that the client device 400 can include, for example, other modules, devices, and/or processors known in the art and/or varieties of the illustrated modules, devices, and/or processors. It should be understood that the modules and/or devices illustrated in the client device 400 can be located within the client device 400 and/or connected to the client device 400 (e.g., directly, indirectly, etc.), but outside of the physical components of the client device 400 (e.g., server computer, shared, scaleable computers such as a cloud computing environment, personal computer, mobile device, etc.).

The communication module 405 communicates data and/or information to/from the client device 400. The user authentication module 410 authenticates users for the client device 400 and/or the dashboard management module 415. The dashboard management module 415 manages a dashboard including one or more user interfaces providing one or more views of data concerning performance of ETL jobs. The dashboard may provide users (e.g., administrators) with easy access to the overall state of the ETL environment. For example, the dashboard may provide status of various ETL jobs at the job level and/or at various summary levels (e.g., run group, etc.).

The dashboard may allow users to define one or more service level agreements (“SLA”) and receive alerts when the ETL system is not meeting these service level agreements. The dashboard management module may include a rules engine executing rules based on the terms of a service level agreement (“SLA). In some embodiments, the rules including run time rules may be defined by a user (e.g., while the application is running) based on the terms of the SLA. In other embodiments, rules may be pre-defined in the dashboard as business requirements of the application.

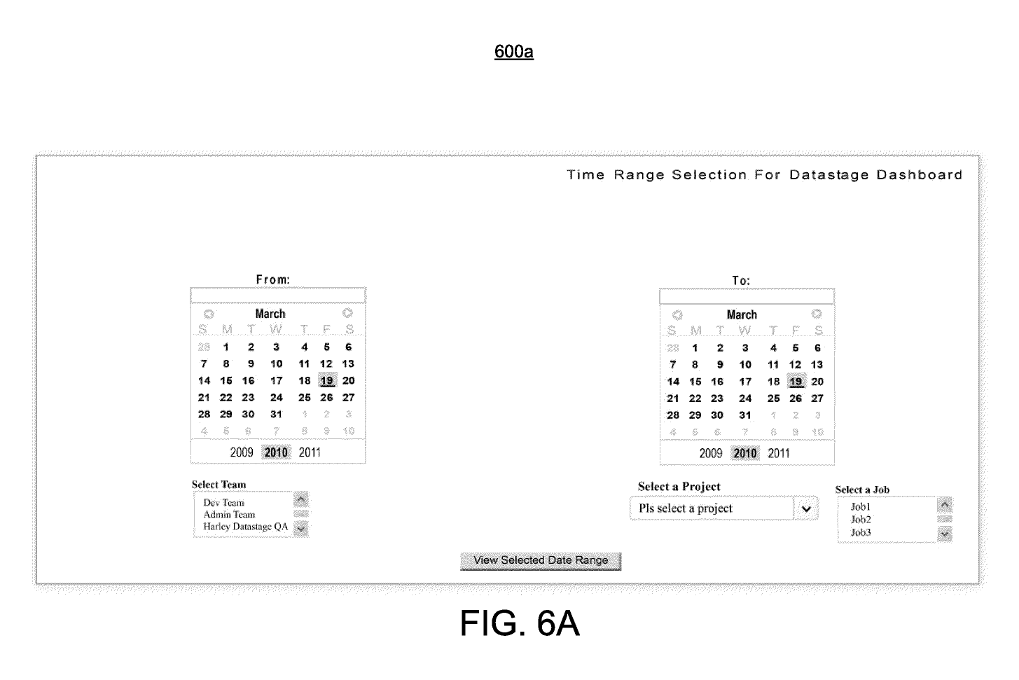

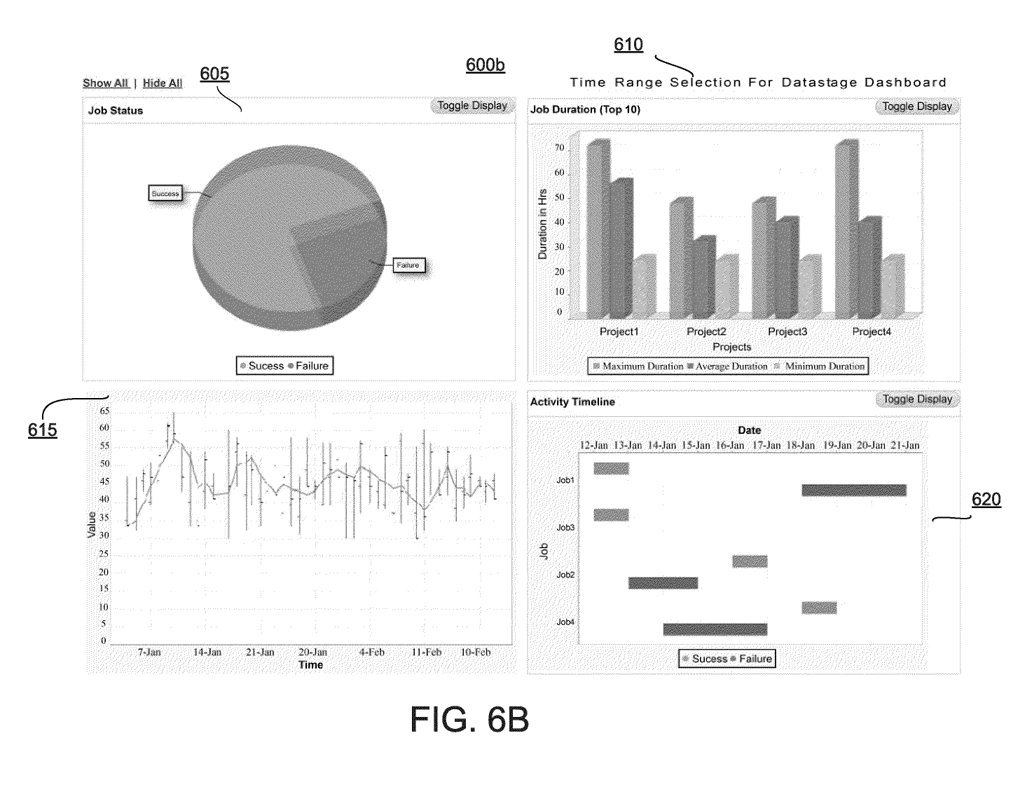

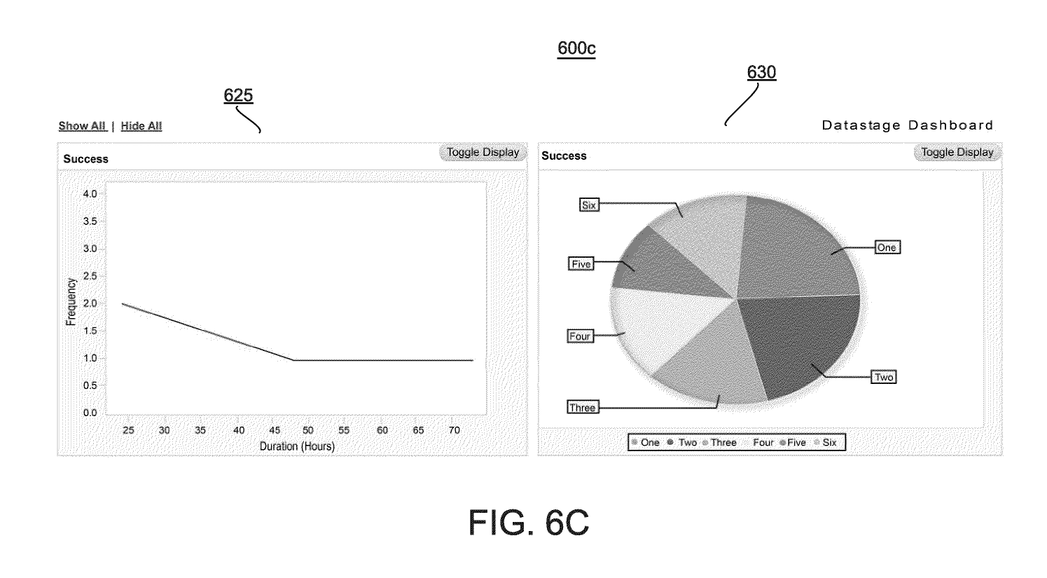

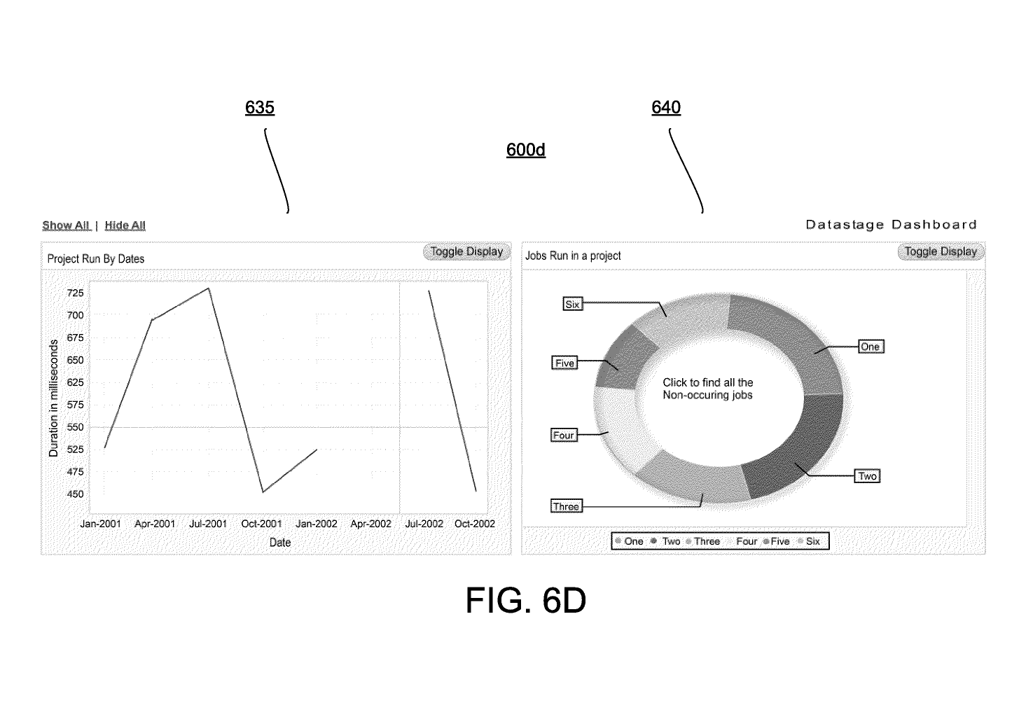

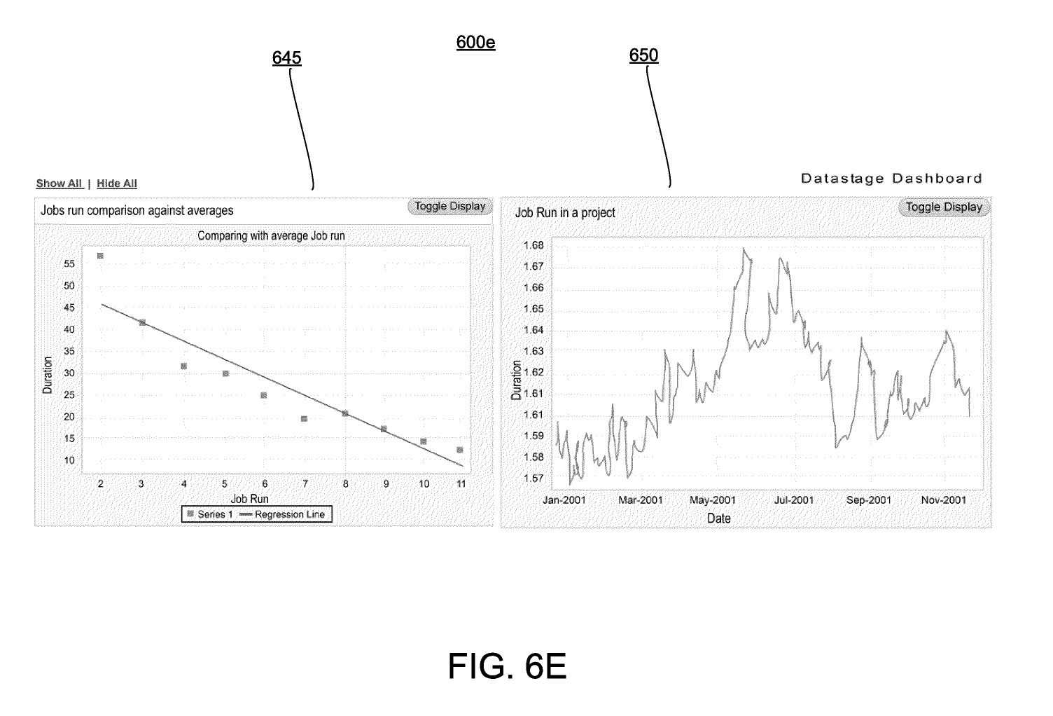

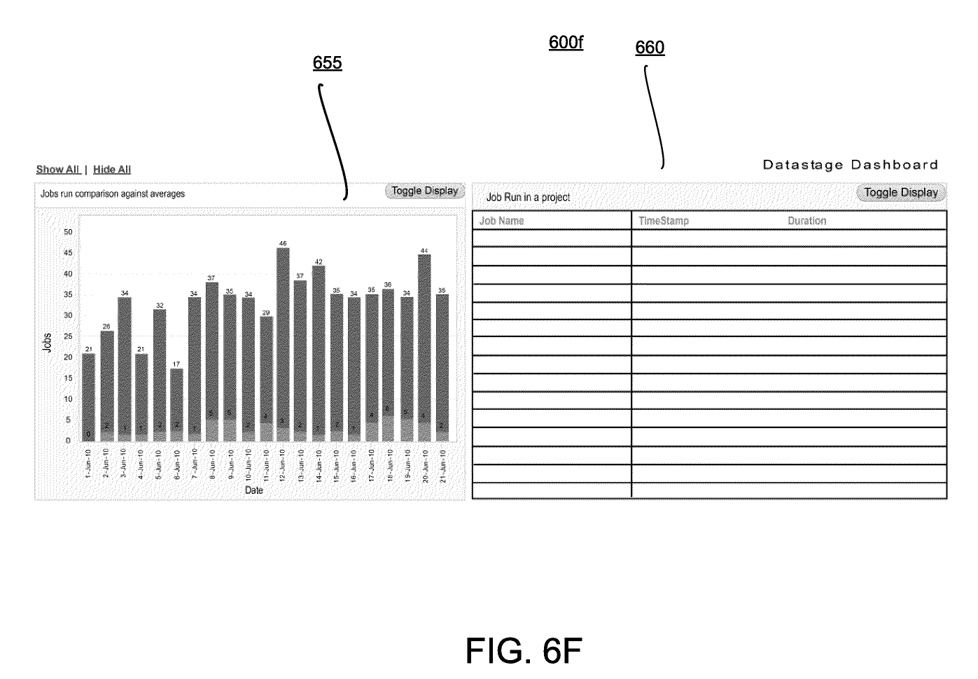

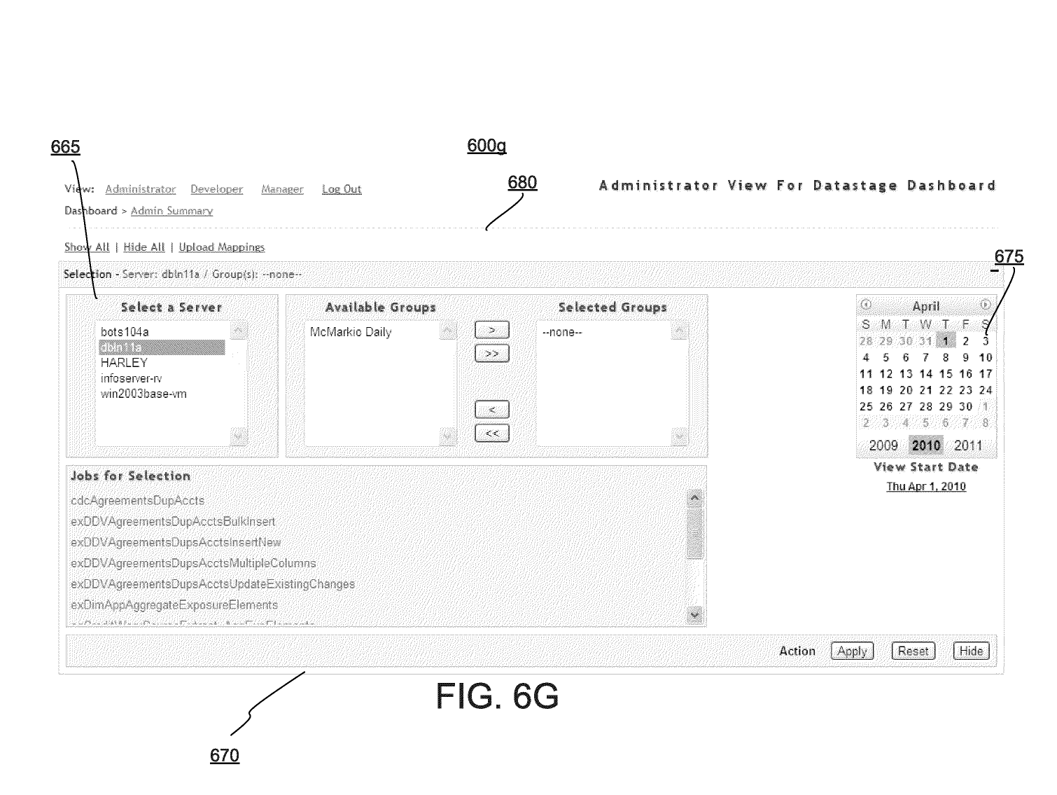

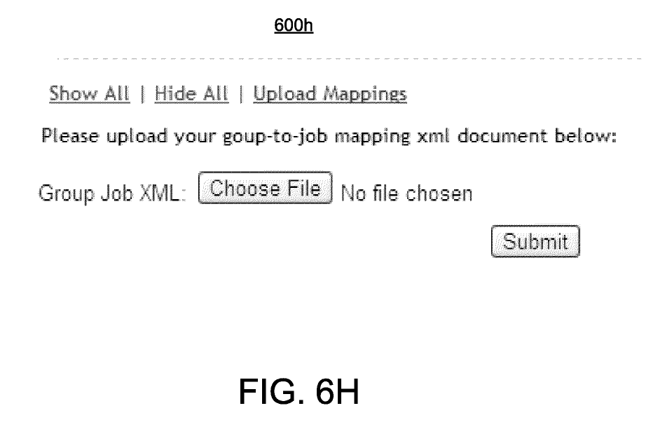

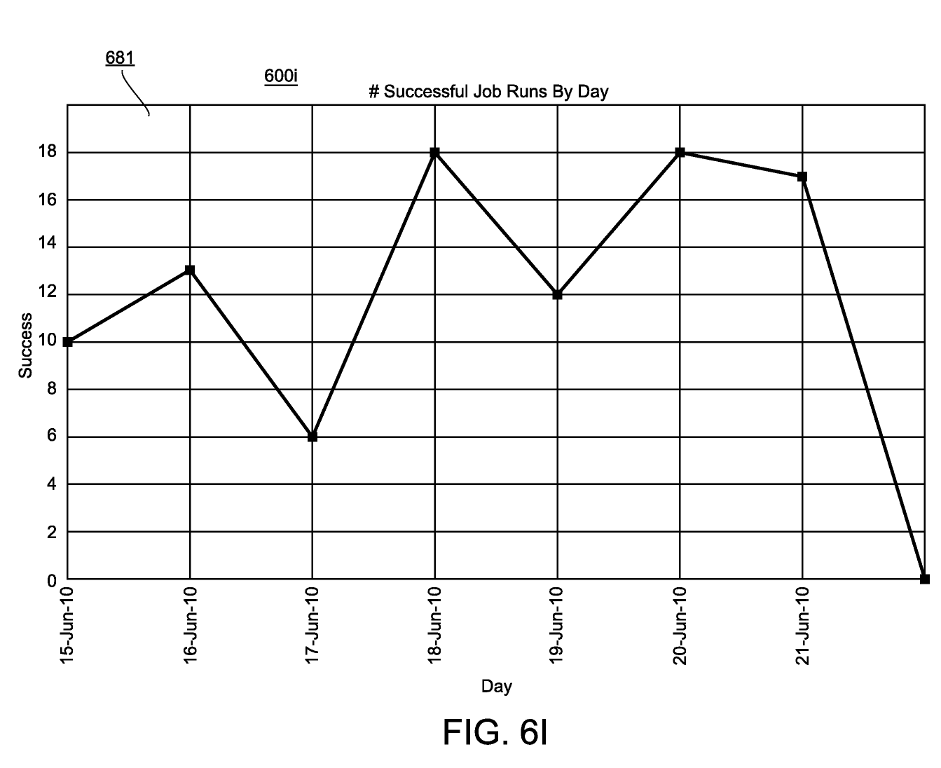

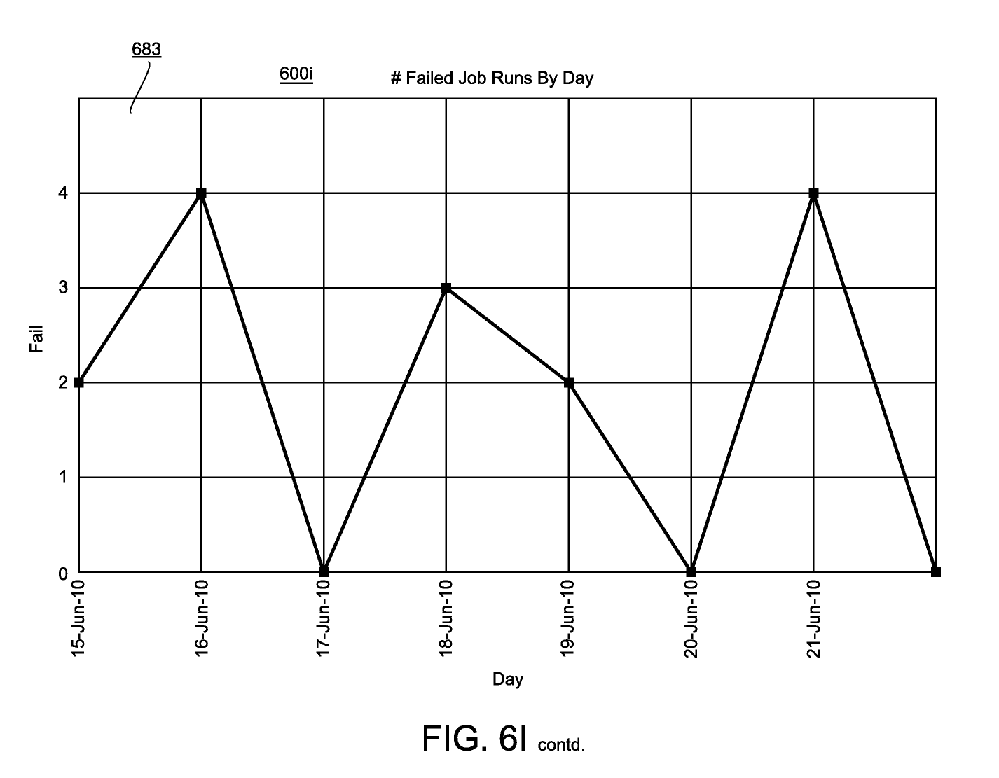

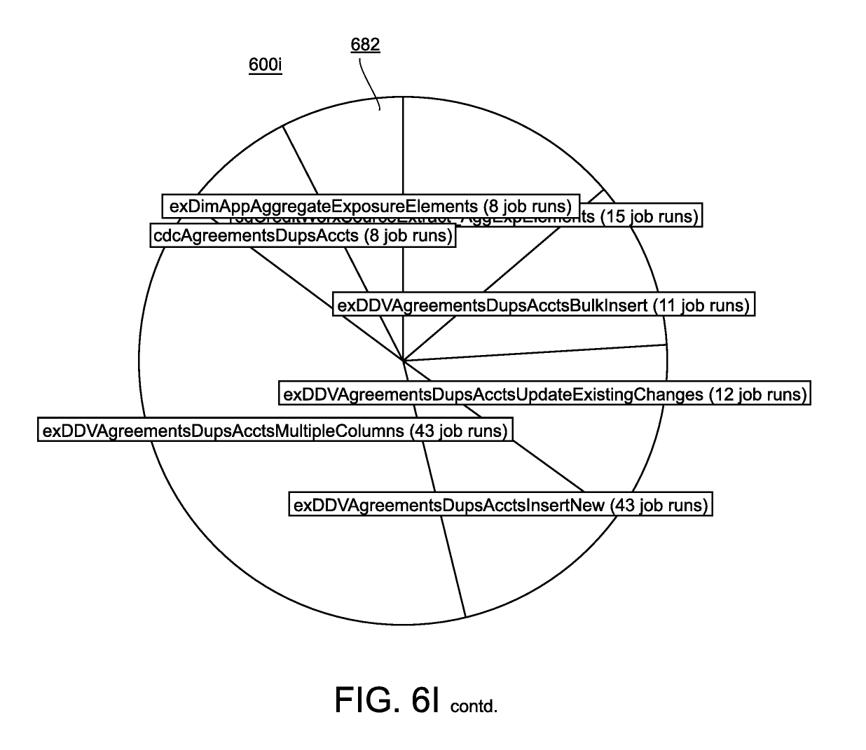

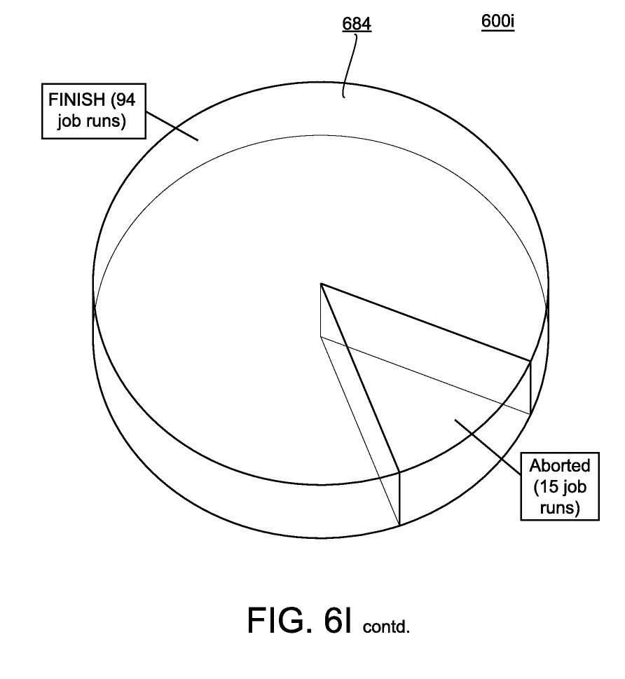

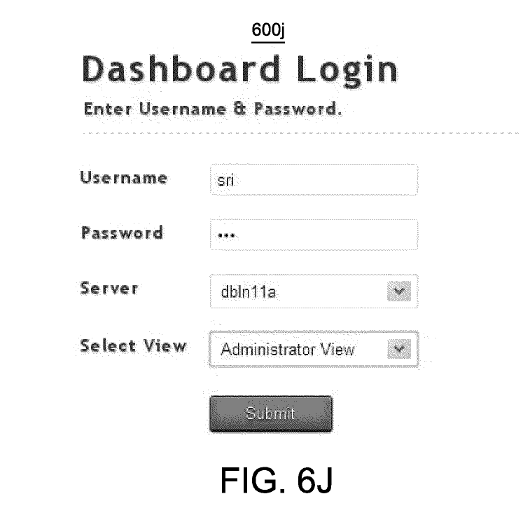

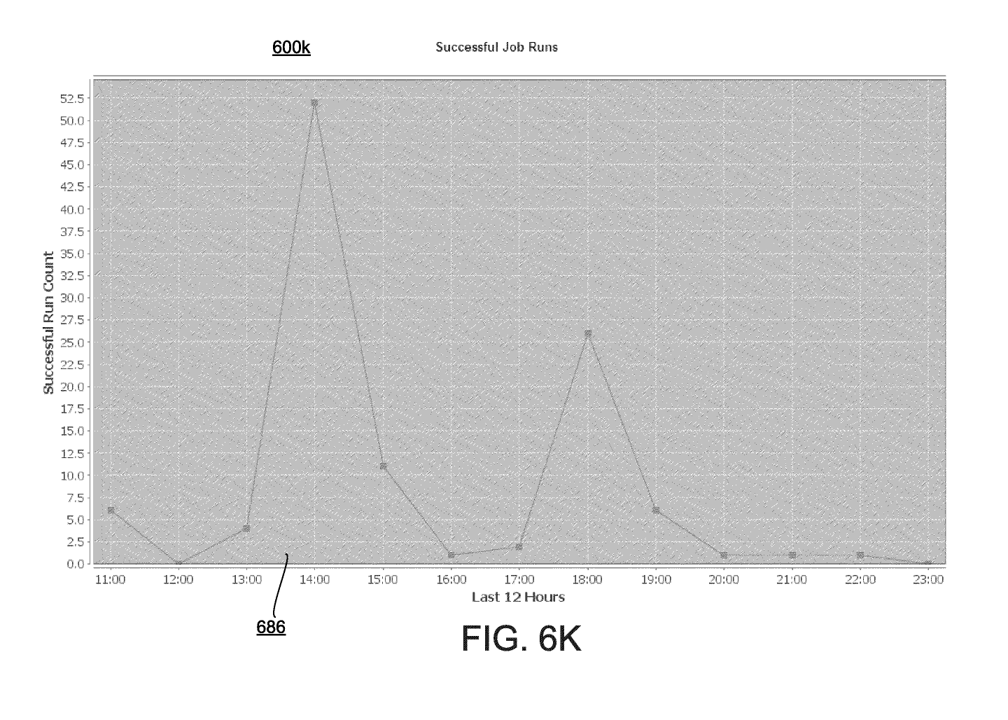

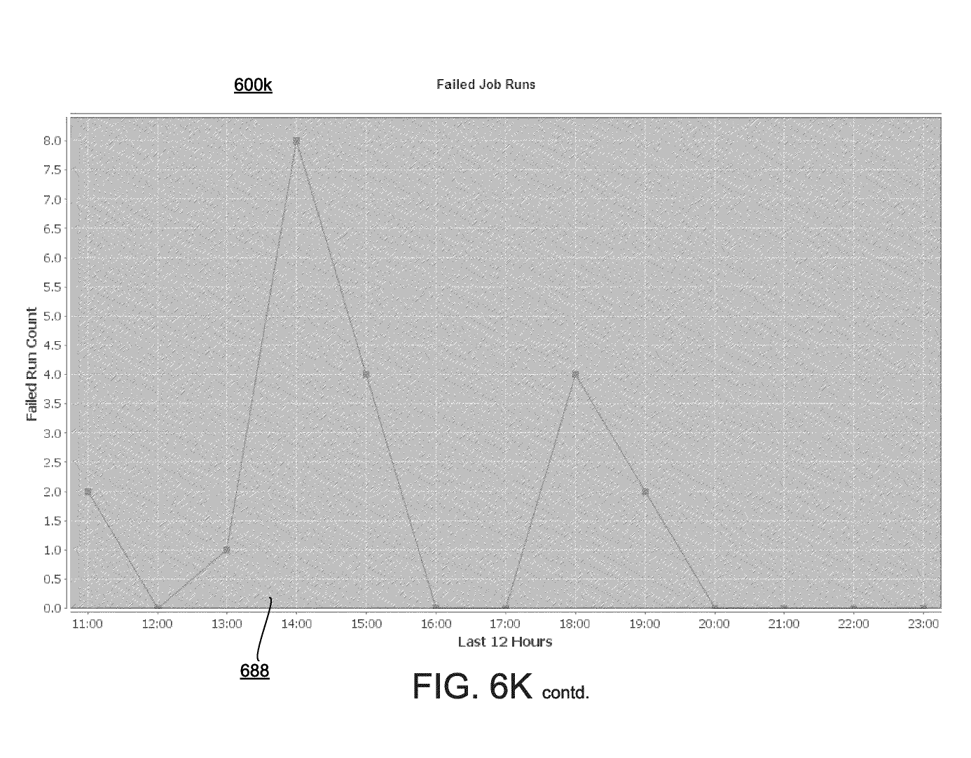

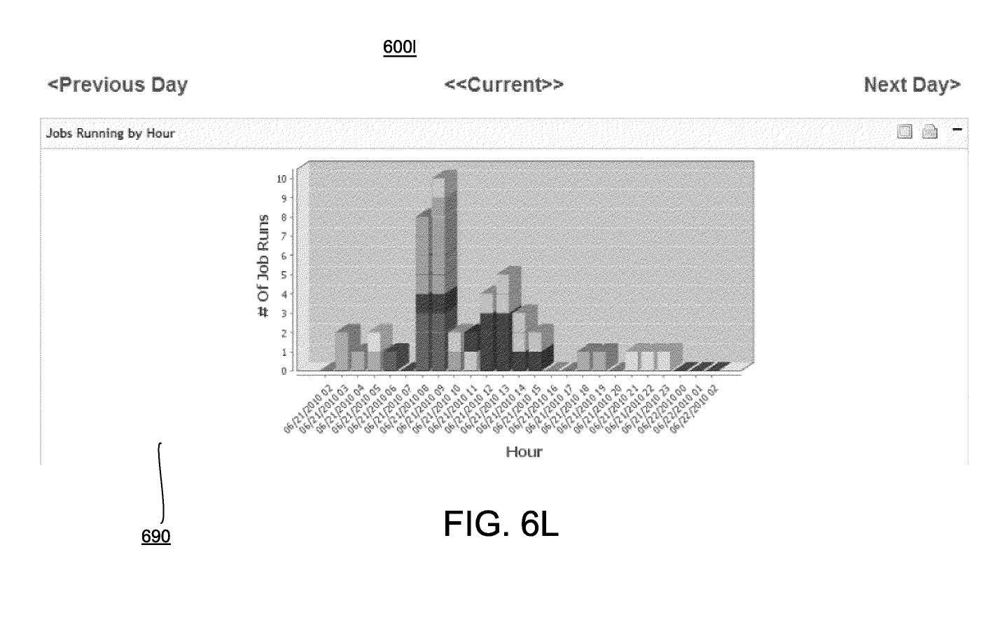

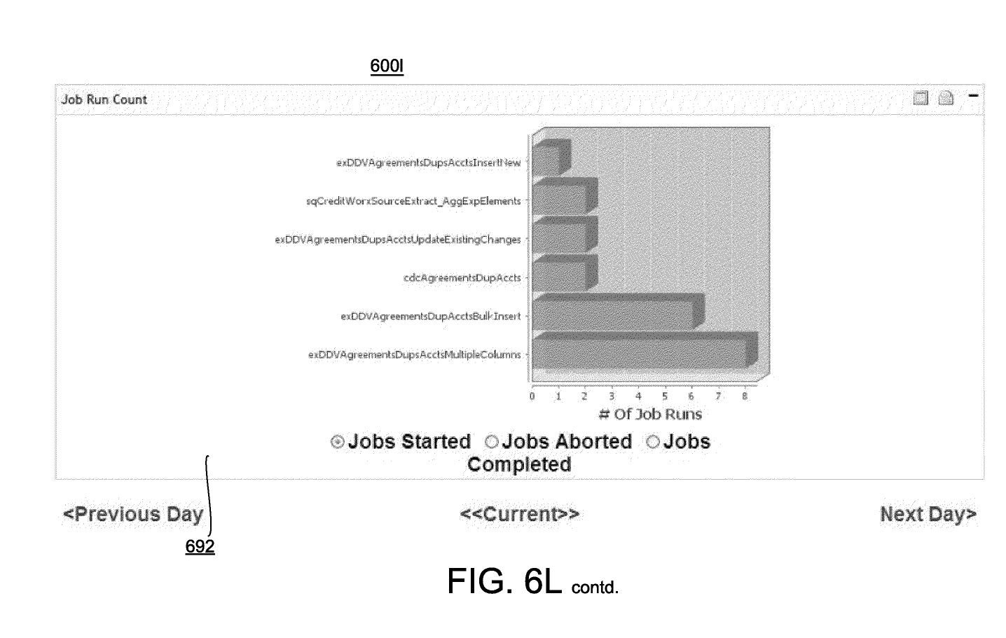

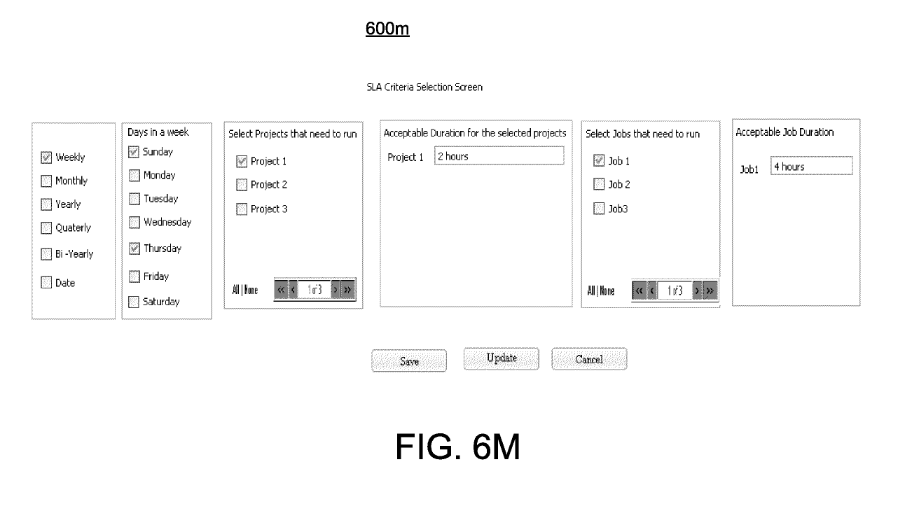

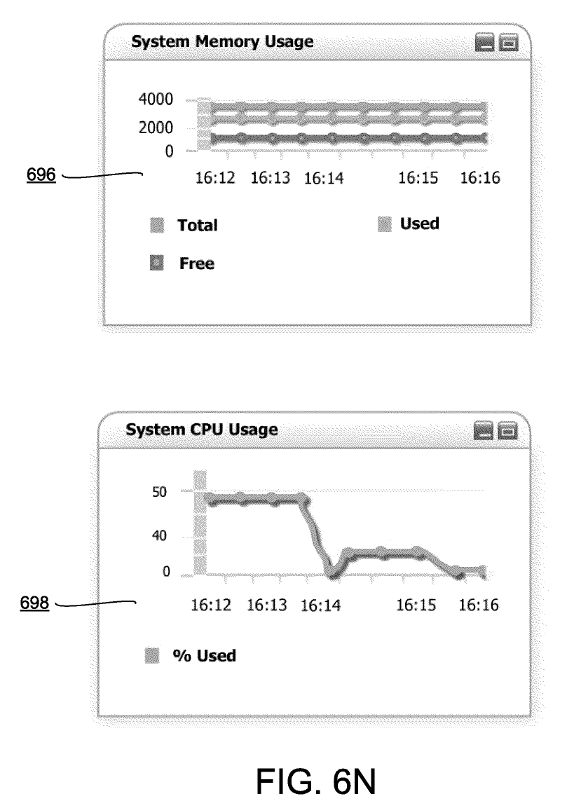

The dashboard management module 415 may provide one or more interfaces enabling users to define job subscription groups as well as to assign jobs to the job subscription groups. For example, users can subscribe a job to a job subscription group based on ETL activities, project, category or any other logical block by which the job may need to be classified. In some embodiments, a job can be assigned to more than one job subscription group. A job subscription group may include one or more jobs. Using the job subscription groups, users may be able to verify the status of the jobs that they are interested in. Accordingly, users are provided with a focused result set to adhere to individual's preferences for display. FIG. 6G illustrates an exemplary user interface for assigning jobs to a job subscription group.

The operating system module 420 operates an operating system on the client device 400. The application module 425 operates one or more applications on the client device 400.

The output device 460 outputs information and/or data associated with the client device 400 (e.g., information to a printer (not shown), information to a speaker, etc.). The input device 465 receives information associated with the client device (e.g., instructions from a user, instructions from a computing device, etc.) from a user (not shown) and/or a computing system (not shown). The input device 465 can include, for example, a keyboard, a scanner, an enrollment device, a scale, etc.

The processor 470 executes the operating system and/or any other computer executable instructions for the client device (e.g., executes applications, etc.). The client device 400 can include random access memory (not shown). The random access memory can temporarily store the operating system, the instructions, and/or any other data associated with the client device. The random access memory can include one or more levels of memory storage (e.g., processor register, storage disk cache, main memory, etc.).

The storage device 475 stores the files, user preferences, backup sets, access information, an operating system and/or any other data associated with the management server (e.g., site management server, data center management server, etc.). The storage device 475 can include a plurality of storage devices. The storage device 475 can include, for example, long-term storage (e.g., a hard drive, a tape storage device, flash memory, etc.), short-term storage (e.g., a random access memory, a graphics memory, etc.), and/or any other type of computer readable storage.

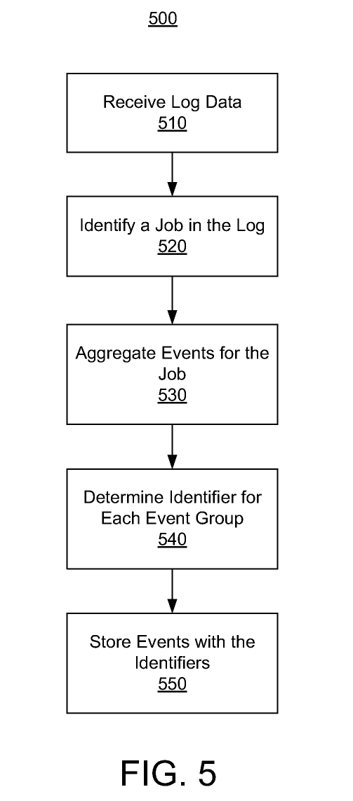

In FIG. 5, a flow chart 500 relating to processing data associated with one or more jobs performed by one or more ETL tools is shown, according to an exemplary embodiment, utilizing the ETL data management server 300 of FIG. 3. The log management module 315 receives (step 510) log data from an ETL tool. In some embodiments, the log management module 315 extracts log data from the ETL tool. The log management module 315 may store extracted log data in the storage device 375. The extracted log may comprise data associated with a job including project name, job name, timestamp of the job, job progress, job errors, event details associated with the job, and/or job sequence.

At step 520, the log management module 315 may identify a job in the log. For example, the log management module 315 may search for a word (e.g., “job”) indicating that the data corresponds to a job. The log management module 315 may maintain a list of all jobs (e.g., stored in a jobs table in the database). At step 530, the ETL job management module 320 may aggregate events found in the log. In some embodiments, the ETL job management module 320 may aggregate events into run groups using event details from the log. For example, the ETL job management module 320 may analyze an event type field to determine if it has a value indicating start or end of a job run (e.g., “finish”). Once start and end events are identified, the event records may be parsed to update the records with an auto generated identifier for each run group (step 540). At step 550, the ETL job management module 320 may update records (e.g., an events table in a database) with event data extracted from the log, along with the generated run group identifier.

FIGS. 6A-6G illustrate screenshots of interfaces allowing users to monitor performance of an ETL environment. An exemplary user interface 600a shown in FIG. 6A allows the user to select criteria for viewing information regarding jobs satisfying the selected criteria. For example, the user can select a date range, a team (e.g., development team, administrator team, quality assurance team, etc.), a project, and/or one or more jobs. A single user may belong to one or more teams. Based on a selected team, one or more projects associated with the team may be loaded for selection by the user. In a preferred embodiment, one or more jobs are associated with a single project.

FIGS. 6B-6F illustrate screen shots of interfaces displaying various statistics regarding performance of ETL jobs based on the selections made in the user interface 600a. In FIG. 6B, a user interface 600b provides four visual representations of ETL job activity. The user interface 600b displays a pie chart 605 showing the percentages of success and failures for the jobs selected by the user in the interface 600a. As illustrated, a majority of jobs had a status indicating successful completion. A GANTT chart 620 illustrates jobs occurring on a particular date. The chart 620 displays periods of time in which jobs 1-4 completed successfully or failed. For example, job 1 completed successfully between January 12^{th} and January 13^{th}.

The user interface 600b illustrates a bar chart 610 displaying maximum, average, and minimum duration of project execution for projects 1-4. In some embodiments, the maximum and minimum duration are calculated using averages, maximum and minimum calculated based on the jobs in the project. For example, project 1 exhibited a maximum duration of 70 hours, an average duration of roughly 58 hours, and a minimum duration of 25 hours. A graph 615 illustrates a bar chart displaying maximum, minimum job duration, and average job duration that occurred on a particular date. In some embodiments, the chart 615 may not differentiate between successful and failed jobs. In these embodiments, a drill down interface may show such detailed information.

FIG. 6C illustrates a graph 625 displaying frequency of jobs that succeeded for the chosen duration. In addition, FIG. 6C illustrates a pie chart 630 of projects that have successfully ended. For example, as shown, job one completed successfully more often than the other five jobs. FIG. 6D illustrates a graph 635 showing jobs in a project that ran on particular dates in a chosen date range. The line break shows the non-occurrence of the project on certain dates. FIG. 6D further illustrates a doughnut chart 640 displaying occurrence of multiple jobs in a particular project. The center of the doughnut chart 640 may be a link for the jobs that did not execute in a project. By clicking on the doughnut chart 640, the user may view jobs that have not occurred but were expected to run.

FIGS. 6E-6F allow the user to compare a job run with average historical job run data. Comparative diagrams 645, 650 and 655 display metrics over a period of time. For example, the diagram 645 shows the variance of the clicked maximum or minimum from the average job duration. The X-axis of the diagram 645 shows job runs (e.g., 2, 3, 4, 5, etc.), while the Y-axis shows duration (e.g., 10, 15, 20, 25, etc.). The diagram 645 also displays a fitted regression line. The diagram 650 shows the occurrence of the duration range over a period of time. The X-axis of the diagram 650 shows dates (e.g., January-2001, March-2001, etc.), and the Y-Axis shows duration (e.g., 1.56, 1.57, etc.).

FIG. 6G illustrates a screen shot of a user interface 600g allowing the user to select criteria for filtering the jobs the user is interested in. For example, the user can select a server 665, jobs 670, a date 675, available subscription groups 680, etc. The available subscription groups 680 displays the subscription groups uploaded by the user and provides the ability for the user to filter the results based on the groups that are of interest to the user. In some embodiments, staff performance analysis may be performed using job subscription groups for staff responsible for jobs associated with the job subscription groups.

FIG. 6H illustrates an exemplary interface 600h for uploading an XML file containing a mapping between a job subscription group and one or more jobs. The XML file may consist of a logical name for the job subscription group, and the corresponding jobs that constitute the job subscription group. For example, if the user is responsible for jobs A, B, and C, the end user may load a file consisting of information identifying jobs A, B, and C belonging to a subscription group A. The job subscription group name may be anything well identifiable by the user. The group A would be available as a filter in the dashboard 600g, so that the user can view the results of the jobs A, B, and C.

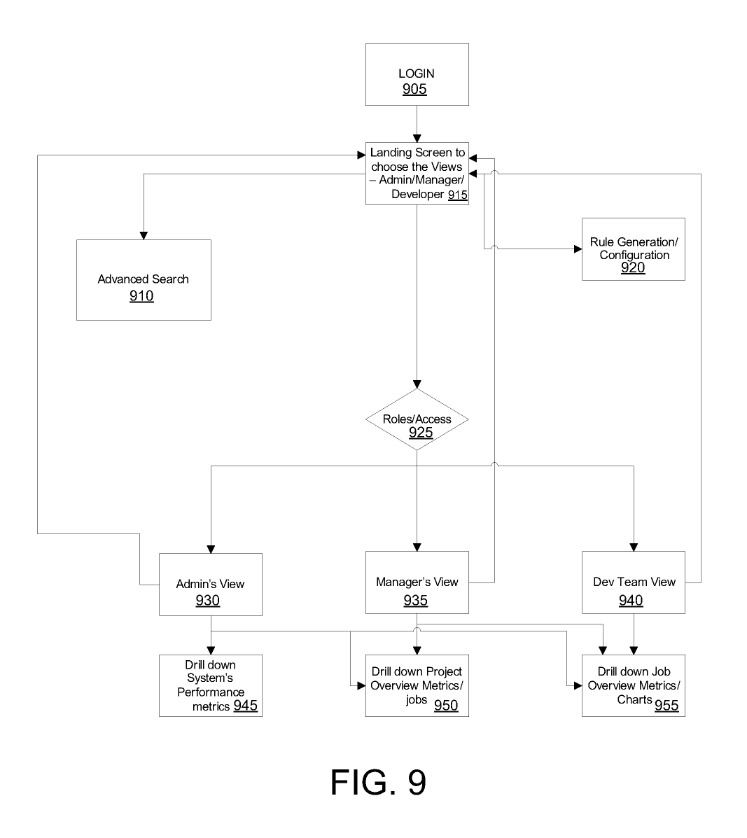

FIG. 6I illustrates an exemplary interface 600i for viewing weekly job activity. In a preferred embodiment, the interface 600i is a manager view (e.g., view 935 in FIG. 9) utilized by a manager end user. The manager view may show the information of all the matching jobs filtered through the advanced search feature (e.g., interface 600g) for a duration of a week. The resulting charts depict the job activity for the week. A success line chart 681 illustrates number of successful job runs by day. For example, there were six successful job runs on Jun. 17, 2010. A failure line chart 683 illustrates number of failed job runs by day. For example, there were two failed job runs on Jun. 19, 2010.

A pie chart 682 illustrates proportion of the job break up with reference to the total jobs that have run on a server. In some embodiments, the proportion is calculated with reference to the job runs for a given job. For example, the job which has forty three job runs has the largest pie slice in the pie chart 682. In a preferred embodiment, a maximum of fifteen jobs would be displayed in the pie chart 682. The fifteen jobs displayed would be the jobs with maximum job runs during the week. A pie chart 684 shows the proportion of all the statuses of the jobs that occurred in the server. The status may include success, failure, warning and error.

In some embodiments, a manager drill down view may be accessed by a user by clicking on any of the dataset points on the charts 681-684. In some embodiments, the manager drill down may display the job run details for the selected job run including job name, start date and time, end date and time, status information, detailed event information such as event identifier, event type, message description, controller run group identifier, extract identifier, etc.

FIG. 6J illustrates an exemplary user interface 600j displaying a dashboard user login prompt. The user interface 600j prompts the user for user name, password, server, and view (e.g., administrator view, manager view, developer view). In some embodiments, the user name may be associated with a view. For example, a user having access to a developer view may not be allowed to access the manager view.

FIG. 6K illustrates an exemplary user interface 600k displaying ‘12 hour’ views of the job activity for the chosen server. In a preferred embodiment, the user interface 600k may be viewed by an administrator (i.e., administrator view 930). The user interface 600k may display information of all the matching jobs filtered through the ‘Advanced Search’ feature (e.g., 600g) for a duration of 12 hours. Accordingly, the resulting charts 686 and 688 depict the job activity for 12 hours. A success line chart 686 shows number of successful job runs by hour. The X Axis of the chart 686 shows the 12 hours of the day for which the Chart is being drawn, while the Y Axis shows the count of successes for the week. For example, as illustrated, there was one successful run at 6 AM. A failure line chart 688 displays number of failed job runs by hour. The X Axis of the chart shows the 12 hours of the day for which the chart 688 is being charted, while the Y Axis shows the count of failures for 12 hours. For example, as illustrated in chart 688, there were 2 failed job runs at 4 AM.

In some embodiments, an administrator drill down view may be accessed by a user by clicking on any of the dataset points on the charts 686 and 688. In some embodiments, the administrator drill down may display the job run details for the selected job run including job name, start date and time, end date and time, status information, detailed event information such as event identifier, event type, message description, controller run group identifier, extract identifier, etc.

FIG. 6L illustrates an exemplary user interface 600l displaying number of jobs running by hour. In a preferred embodiment, the user interface 600l may be viewed by a member of a development team (i.e., developer view 940). Charts 690 and 692 relate to a ‘24 hour’ view of the job activity for a chosen server. For example, the developer view may show the information of all the matching jobs filtered through the ‘Advanced Search’ feature (e.g., 600g) for a duration of 24 hours. The resulting charts 690 and 692 depict the job activity for the 24 hours. The chart 690 displays number of job runs by hour. The X Axis of the chart 690 shows the 24 hours of the day for which the chart is being drawn, while the Y Axis shows the number of the job runs. In some embodiments, the Y axis may show a maximum of ten job runs.

The chart 692 illustrates number of job runs for each job. The X Axis of the chart 692 shows the count of job runs for each job, while the Y Axis shows the job names. In some embodiments, the bar chart 692 includes the top ten jobs that have the maximum job runs.

The chart 692 may be shown based on the following job status selections: jobs started, jobs aborted, and jobs completed. Selection of “jobs started” status would cause the chart 692 to be refreshed in order to show a list of the jobs that have started and the corresponding ‘run count’ of the same. Selection of the “jobs aborted” status would show the list of the jobs that were aborted and the corresponding “run count” of the same. Selection of the “jobs completed” would show the list of the jobs that were completed at the time that the jobs are being charted. In some embodiments, a pre-set maximum (e.g., 15 top jobs) of jobs may be displayed in the charts.

In some embodiments, a developer drill down view may be accessed by clicking on any of the dataset points on the charts 690 and 692. In some embodiments, the developer drill down may display the job run details for the selected job run including job name, start date and time, end date and time, status information, detailed event information such as event identifier, event type, message description, controller run group identifier, extract identifier, etc.

FIG. 6M illustrates an exemplary user interface 600m for further defining rules for jobs based on terms of an SLA. In some embodiments, the success and failure parameters may be different for individual users depending on the role that they would belong to (e.g., administrator, manager, or developer). Hence the user interface 600m may be accessible to those who have “configuration” access to their individual roles. For example, using the user interface 600m, the end user may define an acceptable duration for a job. The selections made in the user interface 600m may affect results displayed by other user interfaces associated with the SLA. For instance, the rules defined by the user may used to show the difference in a job run compared to expected SLA.

FIG. 6N illustrates exemplary charts 696 and 698 representing the system performance parameters. Chart 696 displays system memory usage, while chart 698 illustrates system CPU usage. Other charts may show maximum memory and CPU usage while a process is running. In some embodiments, the charts 696 and 698 are accessible by an administrator and/or by a developer.

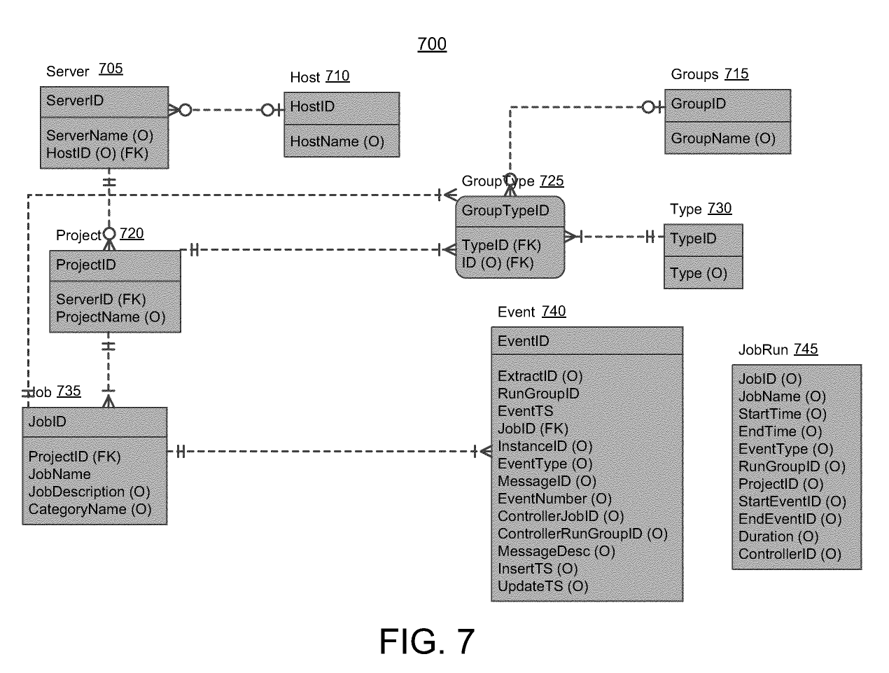

FIG. 7 illustrates an exemplary logical data model 700. As illustrated, the logical data model 700 may include a server structure 705, a host structure 710, a groups structure 715, a project structure 720, a group type structure 725, a type structure 730, a job structure 735, an event structure 740, and a job run structure 745. In some embodiments, the structures may be database tables, flat files, etc. As shown, the server structure 705 may store a server identifier, a server name, and a host identifier. The host structure 710 may store a host identifier, and a host name. The groups structure 715 may store a group identifier, and group name. The project structure 720 may store a project identifier, a server identifier, and a project name. The group type structure 725 may store a group type identifier, a type identifier, and an identifier. The type structure 730 may store a type identifier, and a type.

Also, as illustrated, the job structure 735 may store project identifier, job name, job description, and category name. The event structure 740 may store event identifier, extract identifier, run group identifier, event TS, job identifier, instance identifier, event type, message identifier, event number, controller job identifier, controller run group identifier, message description, insert TS, and update TS. In turn, the job run structure 745 may store job identifier, job name, start time, end time, event type, run group identifier, project identifier, start event identifier, end event identifier, duration, and controller identifier. As illustrated, a job may correspond to one or more events, and a project may correspond to one or more jobs. In some embodiments, the illustrated structures may include additional fields. In other embodiments, one or more of the fields in the illustrated structures may be optional.

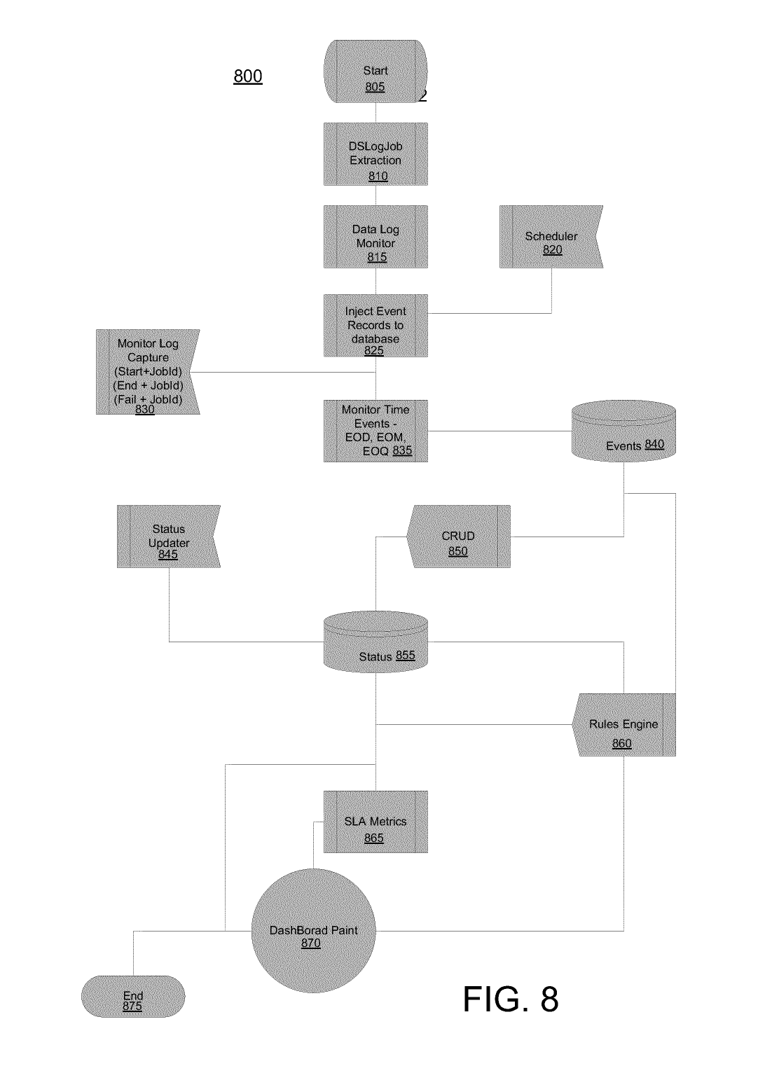

FIG. 8 illustrates an exemplary process flow diagram 800. At step 810, the log management module 315 may extract logs from an ETL tool. The log management module 315 may monitor (815) data stored in the extracted logs to determine whether new events have occurred. At step 825, event records may be inserted into the database (e.g., event table 840, job run table, and other tables may be updated). The ETL job management module 820 may monitor (830 and 835) events, and group the events into event groups as described in FIG. 5. Using event groupings, rules engine 860, and/or service level agreement (“SLA”) metrics 865, a dashboard 870 may display to the user various statistical and visual representations regarding job performance. FIGS. 6A-6N illustrate exemplary user interface of the dashboard 870.

FIG. 9 illustrates a dashboard block diagram 900. Using a login page 905, the user may enter user identifying information such as user name and/or password. After the validation of the username and/or password occurs, the user may enter job preferences in an advanced search user interface 910 (e.g., user interface 600g in FIG. 6G). For example, the user may be provided with an option to select the data stage server for which the dashboard would be viewed. In some embodiments, job preferences selected by the user are saved for subsequent user logins. In these embodiments, next time the user logs in with the same user name, the preferences for the jobs selected on the previous login will be displayed to the user. The user may select the view of interest to the user at the 915 user interface. The views may include an administrator view 930, a manager view 935, and a developer view 940. Based on the view selected, different views of data may be provided to the end user. For example, an administrator may be able to view the system's performance metrics (945), while a manager may be able view project overview metrics (950). A development team member may be able to view more detailed performance data such as job overview metrics and charts (955).

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by, and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. A computer may comprise a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The communication networks can include, for example, packet-based networks and/or circuit-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The client device can include, for example, a computer, a computer with a browser device, a telephone, an IP phone, a mobile device (e.g., cellular phone, personal digital assistant (PDA) device, laptop computer, electronic mail device, smart phone, etc.), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

As used in this application, the terms “component,” “module,” “system,” and the like are intended to refer to a computer-related entity, either hardware, firmware, a combination of hardware and software, or software in execution on a suitable processing circuit. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Moreover, various functions described herein can be implemented in hardware, software, firmware, or any combination thereof. If implemented in software, the functions can be stored on or transmitted over as one or more instructions or code on a computer-readable medium. Computer-readable media is non-transitory in nature and includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any physical connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for managing extract, transform, and load (ETL) jobs, the method comprising:
receiving a log containing data for one or more events associated with an ETL job;
identifying one or more job runs for the ETL job using start event and end event data stored in the log;
aggregating the one or more events for each identified job run based on one or more event fields in the log;
determining an identifier for each aggregated group of events; and
storing the one or more events with the corresponding identifiers in a database.

2. The method of claim 1, wherein the log is received from an ETL tool.

3. The method of claim 1, wherein the log comprises an ETL job identifier, a project identifier, and event data.

4. The method of claim 1, wherein the log contains data for a plurality of additional ETL jobs.

5. The method of claim 1, wherein the one or more event fields include an event type field.

6. The method of claim 1, wherein the database stores historical data associated with previous job runs of the ETL job.

7. The method of claim 6, further comprising:
determining an average run time for the ETL job using the historical data; and
determining standard deviation for the one or more job runs associated with the ETL job based on the average job run time.

8. The method of claim 7, further comprising:
displaying the standard deviation and the average job run data on a user interface.

9. The method of claim 1, wherein the database stores one or more rules associated with the ETL job.

10. The method of claim 9, wherein the one or more rules are received from a user interface.

11. The method of claim 10, further comprising:
using the one or more rules and the received log data, determining that a required job run did not occur.

12. The method of claim 11 further comprising:
sending an alert to a user interface, the alert indicating that the required job run did not occur.

13. The method of claim 1, wherein the database stores one or more service level agreement rules.

14. The method of claim 13, wherein the one or more service level agreement rules are defined by a user, the one or more service level agreement rules are based on a service legal agreement.

15. The method of claim 13, further comprising:
tracking compliance of the one or more events with the one or more service level agreement rules; and
sending an alert to the user indicating non-compliance with the one or more service level agreement rules.

16. A method for managing extract, transform, and load (ETL) jobs, the method comprising:
receiving data for a group of ETL jobs, the group data including data for one or more ETL jobs;
storing the received group data in a database, wherein the database stores event data associated with the one or more ETL jobs; and
providing a user interface to display consolidated data associated with the one or more ETL jobs using the group data.

17. The method of claim 16, wherein the group data includes data for a second group.

18. The method of claim 16, wherein the received data is in XML format.

19. The method of claim 16, wherein the group data is received from a user interface.
